(19) United States
(12) Patent Application Publication
(10) Pub. No.: US 2003/0070140 A1
(43) Pub. Date: Apr. 10, 2003

(54) Tool and method for assistance with creative thinking

(75) Inventor: Gad Sneh, Tel-Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: MTOT Insight Ltd.

(21) Appl. No.: 10/259,585

(22) Filed: Sep. 30, 2002

Related U.S. Application Data
(60) Provisional application No. 60/327,794, filed on Oct. 10, 2001.

(51) Int. Cl. G09G 5/00

(52) U.S. Cl. 715/512

(57) ABSTRACT

Creative thinking tool, operative on text, the tool comprising: a text marking function for allowing a user to mark portions of text; and a feed forward mechanism, associated with the marking function, for assisting with propagation of the text by opening a new block of text. The user then selects marks and associates them with the new block to form a framework for generating new text. The marks retain their association with their points of origin in the text, allowing the user to refer instantaneously and intuitively to their respective contexts. The tool may also include a spatial expositor for arranging user selected marked portions in a layered spatial arrangement, thereby to display graphically, structural relationships within the text.

### FIELD OF THE INVENTION

The present invention relates to a tool for assistance with creative thinking and more particularly but not exclusively to a tool for encouraging or facilitating creative thinking that is usable in association with computerized text and text creation, and/or for encouraging or facilitating heterogeneous conception formation.

### BACKGROUND OF THE INVENTION

The idea of invention or creative thinking has always been on the agenda of the evolutionary and revolutionary milieu. In order to compete it is often not sufficient to do more of the same only better, but it may be necessary to achieve the creation of novel and inventive material, whether in technology or the fields of aesthetics, or strategy. In particular, to use the terms of the Red Queen Hypothesis, in order to survive one must constantly evolve. He who does not change, will find himself irrelevant to continually emerging contexts. Hence, one cannot afford to hold on to pre-existing ideas when projecting upon a context, but is committed to the act of idea creation in order to make relevant sense.

One may thus consider contextual change as an a priory condition on account of both the medium's change and one's own change. Since life is a continuum of successive contexts that differ from one another, there is always a quest of understanding and re-orientating oneself within the different media with which one interacts in any given context. On the one hand, invention becomes a means to understand new contexts, and on the other hand invention provides for an ability to pro-actively affect contexts.

The developmental psychologist Piaget was one of the first to employ methodologically the notion that our ideas are solely dependent on the construction of subjective interpretations. In his theory, Piaget considers two levels in comprehending adaptation as a pro-active operation, encompassing subjective interpretation. On the practical level of survival, adaptation is a matter of devising schemas of action that circumvent obstacles and perturbations placed by the environment in the organism's path. It is a process of assimilation—the way in which we transform new information so that it makes sense within our existing knowledge base; which is to say we try to understand the ‘new’ in terms of our existing knowledge. On the conceptual level, a level providing the underlying structure of interpretation for assimilation, adaptation is a matter of achieving a coherent balance that avoids internal contradictions. It is a process of accommodation—the changing of our cognitive structure in an attempt to understand new information. Thus, information functions differently in relation to the two levels of adaptation. In the process of assimilation, information functions as the counterpart for the homogeneous manipulation and coordination of our existing understandings in relation to contexts. Yet, in the process of accommodation, information functions as the inspiration agent for invention—a catalyst for the deconstructing process of creating a new heterogeneous interpretation of the context.

Koestler suggested that the basis of creativity is the “perceiving of a situation or an idea in two self-consistent but habitually incompatible frames of reference” (Wilkins, 1988, pp. 351-352). Thus, in order for one to conceive matters differently, one must be able to conceive a different referential ground for it. The problem that creative thinking and invention are faced with is how to focus not on the mere subject-matter, but on the frame of reference within which the subject-matter's interpretation emerges, and on the process of structuring, rather than on the structure representing the content of the subject-matter.

In conclusion, a continuously emerging context necessitates a corresponding emergence of innovation on the part of the observing participant. Creative thinking and invention are not simply desirable but rather essential, as one cannot escape the challenge of adaptation. In the process of adaptation, accommodating, as opposed to mere assimilating, requires a change in approach, addressing the structuring dimension in creative thinking and inventive processes.

Existing approaches attempting to provide facilitating solutions for creative thinking, invention and more generally innovation, may be classified as follows:

1. Decision-making systems.

2. Free associative brainstorming systems.

3. Meta-cognitive schema projection systems.

Decision-making systems attempt to deal with adaptation by presenting the user with already made functions (decision-making expert systems), through which he or she may arrive at a solution, or they provide an ability to project his or her own functions, and work through them. Since there is no critical thinking regarding the functions themselves, decision-making systems fall in the category of systems that deal with adaptive assimilation—the functions represent our existing knowledge and the user moves within them in order to fit the ‘new’. Decision-making systems provide for efficiency but do not facilitate in breaking through the user's tendencies, being bound by his or her existing knowledge; thus, they do not assist in arriving at innovation. Decision-making systems are solution oriented. Not only do they not deal with structuring, they do not even attempt to relate to an existing structure as a departing point towards a new structure.

Free associative brainstorming systems recognize the dependency of creative thinking and invention on associations. Such systems provide the user with a virtual environment, allowing him or her to act within it, using different types of textual and multimedia representations, in order to jot down his or her associative thinking. Understanding the need for one to reflect upon one's thinking, these systems provide the user with a virtual mirror on which he or she may reflect their line of thought in any way they choose. Free associative brainstorming systems build an environment for the nurturing of creativity, yet they say nothing about how to work within that environment. Hence, the environment created allows the emergence of differentiation and tension in relation to existing knowledge, yet such emergence is due to associative realizations, and cannot be attributed to the nature of the environment. One may describe this activity as looking at the black box of creativity from the outside, yet, leaving the black box closed.

Meta-cognitive schema projection systems strive to open the black box of creativity, by focusing on thinking-about-thinking processes. These methodologies encourage the user to become aware of the concepts by which he or she is thinking. They force him or her to elicit concepts that are used implicitly, making them explicit and ready for rationalization. Rendering the concepts explicit enables a new bridging between concepts, driving the creation of new concepts not hitherto considered. These systems incorporate the ability to visualize and act on textual and multimedia representations, as in the free associative brainstorming systems, but instead of letting the user move and focus freely on his or her thoughts, they direct the user to a conceptual framework constructing his or her thoughts, and manage the interplay of concept bridging. It is this creation of new bridging spaces between concepts that force the emergence of new concepts, and enable the build-up of thinking frames and mind-sets through which the user may functionally perceive and act. It is through the manipulation of concepts in the thinking-about-thinking domain that cognitive content or subject-matter may emerge holding new meaning. Meta-cognition is supposed to be manifested in thinking-about-thinking, manageable by the departure from the the content or subject-matter layer to a newly developed layer of concepts, thus incorporating bi-polar layer management.

Unfortunately, ascribing meta-cognition as thinking-about-thinking again effectively avoids opening the black box of creativity. All it does is change the focus of thinking—from thinking-about-something to thinking-about-thinking, but it does not deal with the way one thinks. Again, the function with which one handles one's thinking about one's thinking is externally given. In these methodologies, the meaning of meta-cognition—the dealing with the structuring of one's thoughts—is circumvented, as the way of structuring is predetermined. All that such methodologies are able to achieve is dealing with thinking-about-thinking via a given pre-defined structure, instead of introducing a structuring methodology for thinking. Moreover, as with the relation between velocity and acceleration, the former representing first order and the latter second order—the second order encompassing the potential of the first order's changestructure may be represented as first order and structuring as second order. Both first and second orders reside in the same layer of reference, only from a different perspective. The bi-polar layer system, introduced by thinking-about-thinking, represents a dichotomization of layers, hence, de facto creates two first order layers. In conclusion, meta-cognitive schema projection systems merely create another first order layer of structure, instead of dealing with the second order structuring of the first order's structure. Creating a new layer, not only gets around the problem of structuring, but also doubles the structure's problem in the process.

All three attempts, as stated above, fail to create a structured environment for structuring. Decision-making systems avoid structuring altogether and relate instead to already-made structures. Free associative brainstorming systems point to the importance of the creation of a new environment for structuring, yet do not tackle the environment's structure. Meta-cognitive schema projection systems create a structured environment that changes the focus of our thinking, from thinking-about-something to thinking-about-thinking, but fail to reach an understanding regarding the structuring of our thinking. Hence, in all three attempts one remains bound by a certain structure on different domains or meta-domains.

Theoretically and methodologically, the three existing approaches evolve around a stable structural center when thinking about a matter in hand, or thinking upon thinking on the matter in hand. The stable center's function is threefold:

(1) it enables to orient, balance, and organize the structure;

(2) a priori it forces the organizing principle of the structure to limit free play of the structure; and

(3) it forbids further signification, i.e., further substitution and transformation of a structure's contents and terms.

The center is the end-stop of a structure, it is that which closes it off and masks its structurality, i.e., masks its man-made nature. In not addressing the problem of structuring, not only do these approaches not enhance the ability to create, but to a large extent, in fact enforce the pre-existing structures, thus failing to support creative thinking, innovation and concept creation.

### SUMMARY OF THE INVENTION

It is an aim of the present embodiments to provide an environment in which the problem of structuring is addressed. That is to say it is an aim to provide an environment in which the structure of a text can be deconstructed and structured to facilitate creative thinking on the part of a user.

According to a first aspect of the present invention there is thus provided a creative thinking tool, operative on text, said tool comprising:

a mark creator for allowing a user to mark portions of text; and

a feed forward mechanism, associated with said mark creator, for assisting with propagation of said text at a new block in said text, said feed forward mechanism comprising:

a mark ascriber for allowing a user to ascribe selected marks with said new block, and

a selected mark display for displaying said ascribed marks as a framework for creating new text into said new block.

Preferably, said mark ascriber comprises a reference for retaining with each ascribed mark an association with a respective mark of origin in said text, such that an ascribed mark ascribed to a new block is selectable to automatically display a respective mark of origin.

Preferably, a block is selectable to automatically display marks ascribed thereto.

Preferably, said feed forward mechanism comprises a mark text window for displaying of texts of selected marks.

The tool may comprise a search device, associated with said mark creator, for carrying out text searches of said marks.

The tool may comprise a multi-focal viewer for simultaneously displaying a plurality of windows.

Preferably, said multi-focal viewer is operable to simultaneously display a block of origin of an ascribed mark and a block to which said mark is ascribed.

The tool may further comprise a spatial expositor for arranging user selected marks in a layered spatial arrangement, thereby to display graphically, relationships within said text.

The marks may be ascribed marks and respectively comprise references for retaining an association with a respective mark of origin in said text, such that a mark in said layered spatial arrangement is selectable to automatically display a respective mark of origin.

Preferably, said spatial expositor comprises a layering selector for allowing a user to select a layer within said arrangement for placement of a given selected mark.

Preferably, said spatial expositor is interfaceable to users via forms.

Preferably, instances of said forms are generatable from marks.

Preferably, said spatial expositor is operable to create a user determined number of said spatial arrangements, each one of said spatial arrangements being user manipulable.

Preferably, respective instances of said forms are retrievable by reference to corresponding marks.

Preferably, respective mark associations are retrievable via said form.

Preferably, each said mark is assignable to a user selectable one of at least an outer layer and an inner layer of a respective layered spatial arrangement.

Preferably, at least one spatial arrangement comprises outer edges and an inner region, and wherein said outer layer marks are represented in said spatial arrangement by said outer edges and said inner layer marks are located in said inner region.

According to a second aspect of the present invention there is provided a creative thinking tool, operative on text, said tool comprising:

a mark creator for allowing a user to mark portions of text at an originating location; and

a spatial expositor for arranging user selected marked portions in a layered spatial arrangement, thereby to display graphically, relationships within said text.

Preferably, said spatial expositor comprises a reference retainer for retaining with each arranged mark an association with a respective point of origin in said text, such that an arranged mark in said layered spatial arrangement is selectable to automatically display text at said respective originating location.

Preferably, said spatial expositor comprises a layering selector for allowing a user to select a layer within said arrangement for placement of a given selected mark.

Preferably, said spatial expositor is interfaceable to users via an instance of a form.

Preferably, said spatial expositor is operable to create a user determined number of said spatial arrangements, each one of said spatial arrangements being user-manipulable via arrangement of marks.

Preferably, each of said mark associations is retrievable via said form.

Preferably, each said mark is assignable to a user selectable one of at least an outer layer and an inner layer of a respective layered spatial arrangement.

Preferably, at least one spatial arrangement comprises outer edges and an inner region and wherein said outer layer marks are represented in said spatial arrangement by said outer edges and said inner layer marks are within said inner region.

According to a third aspect of the present invention, there is provided text arranged into a plurality of blocks, at least some of said blocks having text associated with marks from respective mark origin ones of said blocks, and each mark comprising textual content and having a context in said respective mark origin block, said text associated with said mark further comprising an activatable association with said mark origin block, thereby to indicate said context, and said marks further being selectable for inclusion into a framework for construction of a new block whilst retaining said activatable association thereby to form an association between said new block and said block of origin.

Preferably, each mark comprises said textual content and said textual context, and wherein said textual context comprises surrounding text in said block of origin and marks assigned to said block of origin.

Preferably, each mark is contextually associated and retrievable via said surrounding text.

Preferably, respective ones of said blocks have associations defined therebetween via marks, thereby to form a structural environment within said text.

According to a fourth aspect of the present invention there is provided a method for providing automatic assistance for creative thinking in textual construction, the method comprising:

marking portions of text,

selecting ones of said marks to form a framework,

displaying said framework simultaneously with a text creation region for stimulating said text formation process.

The method may further comprise providing said selected marks with pointers to respective portions of text, thereby to render said selected marks to be selectable from said framework to display said portion of text for further stimulating said text formation process.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a simplified block diagram showing a creative thinking tool according to a first preferred embodiment of the present invention,

FIG. 2 is a simplified block diagram showing in greater detail the text holding feature of FIG. 1,

FIG. 3 is a simplified block diagram showing in greater detail the feed forward mechanism of FIG. 1,

FIG. 4 is a simplified block diagram showing in greater detail the spatial expositor feature of FIG. 1,

FIG. 5 is a simplified diagram showing a spatial exposition that may typically be generated by the spatial expositor of FIG. 4,

FIG. 6 is a simplified screen view illustrating use of the creative thinking tool of FIG. 1,

FIG. 7 is a simplified screen view illustrating a further aspect of the use of the creative thinking tool of FIG. 1, and

FIG. 8 is a simplified screen view showing a window for managing one or more of the forms of FIG. 4.

### DESCRIPTION OF THE PREFERRED EMBODIMENTS

The present embodiments provide a tool for marking portions, for example central ideas, in texts and then using those portions to provide a framework for creating new texts. Associations are preferably formed between the point of origin of a marked idea and the mark ascribed within the framework and the point at which it is used in a new block of text, thereby to assist in conception formation and in new creation in general.

Use of the tool enables the creative formulation of a text which is arranged in blocks. Some of the blocks are associated with marked texts, each mark comprising textual content originating from another one of the blocks. The mark further comprises an association with its respective originating block, from which its textual content has been taken.

To use the text for conception formation etc. the marks may be arranged to form a framework for respective blocks.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

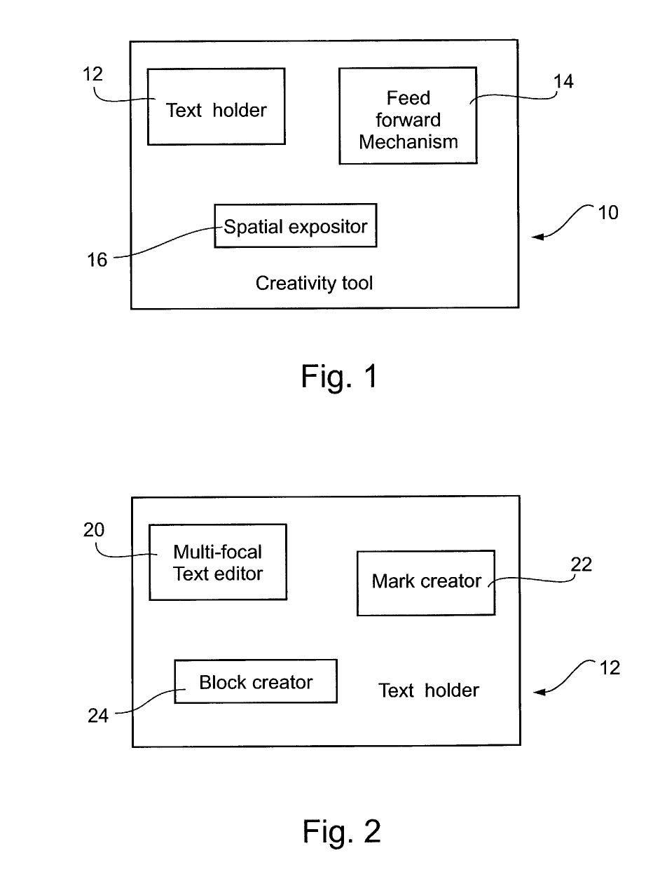

Reference is now made to FIG. 1, which is a simplified block diagram showing a creative thinking tool according to a first embodiment of the present invention. The creative thinking tool 10 preferably operates on text, via a text holder 12. The text holder 12 may be a buffer associated with a standard word processing or other text handling program or may in fact represent such a program per se. The text holder 12 preferably makes available to the tool standard text handling functions such as text input, highlighting, cut and paste and the like. The text-holder, combined with word processing ability, provides a first layer of the tool, allowing a textualization process of the writer's ideas.

The process of textualization commences either with a composition of an initiating text relating to the context in hand, followed by a preliminary reading of the text, or, in the case of a pre-composed text, with a preliminary reading of the pre-composed text.

In accordance with the preferred embodiments, whilst reading the text, a user becomes aware of certain ideas that hold either key lines-of-thought providing for the coherence of the composition, or vague, ambiguous or indistinct descriptions in need of further elaboration. In both cases, such ideas provide building blocks for textualization, either as constructive elements or as elements for deconstruction, as will be explained below. The elements may represent key content points, or they may represent structured lines of thought within the text.

Methodologically, the user may select the above-mentioned elements in the text as they provide the potential for the propagation of an interpretive investigation which is to follow. The selected elements are preferably marked and stored as chunks of text linked by association with their point of origin in the original text. The selecting makes the ideas visually explicit, and the combination of selection and association sets them as boundary defined elements which may subsequently be used as references in the act of textualization, as will be explained below. Hereinafter such text parts, so treated, are referred to as Marks.

The tool 10 further comprises a feed forward mechanism 14, which is a mechanism for allowing the user to select marks and arrange the marks into a framework in relationship to a new block of text to be created. The feed forward mechanism allows the framework to be viewed simultaneously with the new block in a number of ways that are explained in more detail below, and provides a linkage or association between the point of origin of the mark and the new block that is created in its light.

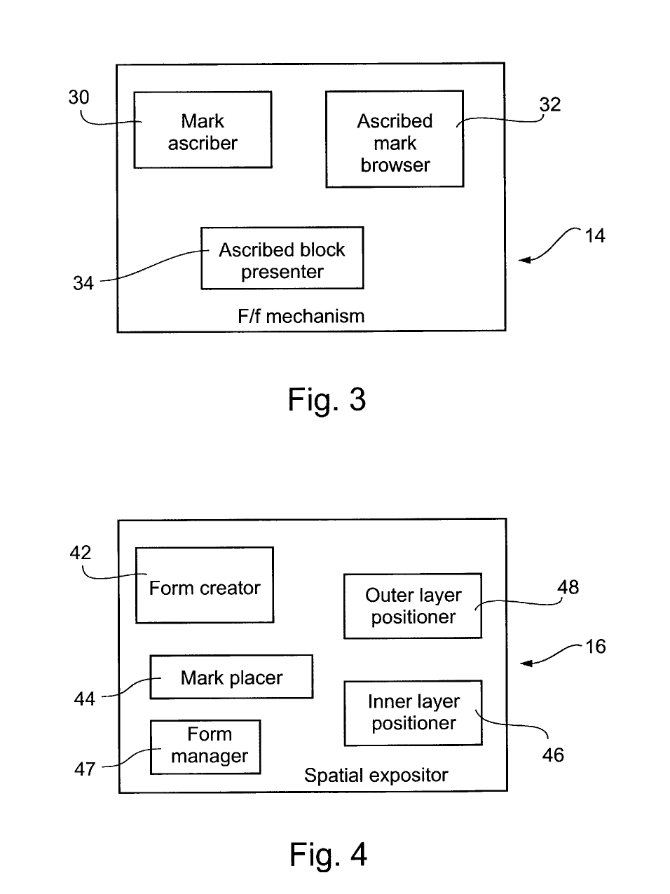

The feed forward mechanism is used by inserting marks into a new framework, and the new framework provides a contextual setting for the structuring of the ideas by the users. The user is thus facilitated in a process of structuring of his ideas, which may assist him in creative writing or concept formation. The feed forward mechanism is considered in further detail in FIG. 3 below. The framework provides what may be termed a feed-forward referential ground, where inter-textual engagements enable the realization of hyper-contextual interplay, hence a buildup of a context dependent particular structuring grounds leading to the emergence of difference which expresses a potential for new writing.

The tool further comprises a spatial expositor 16 for arranging the user's concepts into a graphic format. More specifically, the expositor allows the user to select marks as desired and designate each mark as belonging to an outer or structuring layer and an inner or structured layer. The spatial expositor 16 uses the user-defined designations to provide a graphical arrangement of the marks for the user to view. Thus, the selected marks are displayed in a layered spatial arrangement, graphically showing structural relationships within the text. The layered spatial arrangement, or spatial exposition of the text's structural dimension, may, if properly used, synchronize the morphology's composed content together with its form, allowing a textualization-dependent representation of the inter-textual engagement zone.

The spatial exposition may be useful for general concept representation outside the sphere of creative thinking. Thus it may be useful as a simplified way of preparing a diagram for a slide presentation that illustrates a given text interpretation.

The text holder, the feed forward mechanism, and finally the spatial expositor, comprise three separate layers or frames of the tool. The three working frames interlink methodologically as follows: the first 12 providing the grounds upon which text is written; the second 14, providing for the investigation of idea interrelations through the assignment of different selected portions of the text as references to others; and the third 16, providing for the spatial or graphic representation of chosen references and their interrelations. The use of the second layer allows one to meditate upon the references and their interrelationships, and the graphic representation provides an additional mode for the same meditative interaction, and also provides a means for orientation, as the textual placements upon the graphic exposition may be interlinked to the areas in the text they originated from, as indeed they may be in the first layer.

Reference is now made to FIG. 2, which is a simplified diagram showing the text holder 12 in greater detail. The text holder 12 comprises a multi-focal text editor 20, which allows simultaneous viewing and editing of two or more parts of a text currently being worked on. Generally the text editor is provided as at least two text windows, one of which has already prepared text from which marks are being taken and the other of which displays a place at which a new block of text is being created. The text holder 20 is associated with a mark creator 22, which allows a user to create marks out of selections from the text. The selected texts are marked and may be referred to in subsequent manipulations. A block creator 24 allows the user to create new text with new referential grounds, typically at the end of existing text, and to associate this new block with desired marks using the feed forward mechanism 14, as will be described in more detail below. In a preferred embodiment, the text holder is a word processor offering all of the features of commercially available word processing packages, and for which the creative thinking tool is provided as an add-on. However, it is sufficient for a fully functioning embodiment if the text holder 12 is able to store preprepared text, allow selecting so as to support marking and to allow simple text entry to support the new block creator 24.

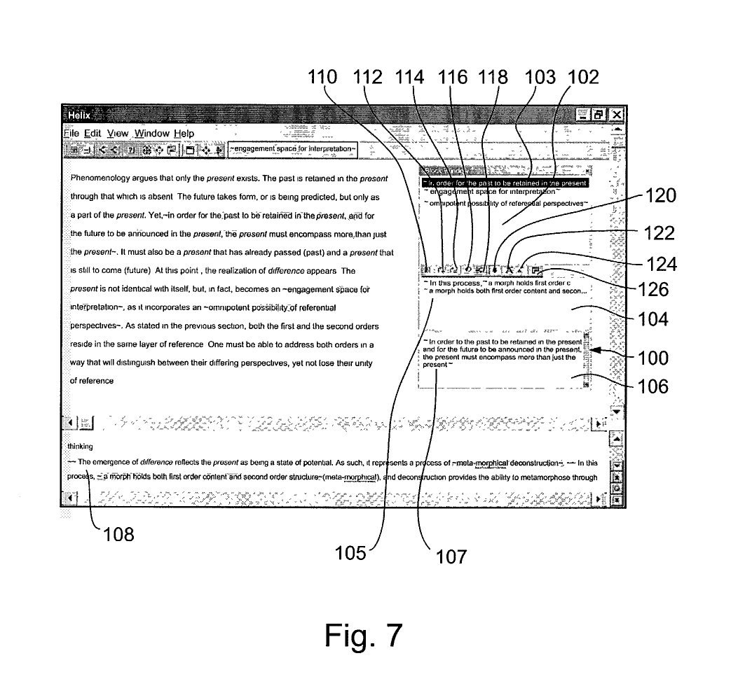

Reference is now made to FIG. 3, which is a simplified diagram showing the feed forward mechanism 14 in greater detail. The feed forward mechanism comprises a mark ascriber 30, an ascribed mark browser 32 and an ascribed block presenter 34. The mark ascriber 30 stores marks created using the mark creator 22 and allows them to be selected, so as to be ascribed to a new block. The ascribed mark browser 32 allows marks in a current framework to be fully viewed or browsed. The ascribed block presenter 34 enables viewing of further blocks or marks that were written in light of the present block. The feed forward mechanism 14 is preferably provided as a multi-focal viewer or browser on screen, with each of the above-described features comprising a separate window therein, as will be described in greater detail with respect to FIG. 7, below. Preferably, the mark ascriber 30 and the ascribed mark browser 32 display only the selected marks.

The marks are preferably stored together with pointers to their places of origin in the original text. The pointers allow the feed forward mechanism to retrieve the place of origin automatically upon selection of the mark.

The feed forward mechanism 14 is preferably used for propagating already expressed ideas of the user either into a new arrangement of those ideas or the creation of new ideas in reference thereto, and is thus brought into use after a certain body of text has already been written and marking has been carried out thereon. The feed forward mechanim is thus used in association with a new block of text, and the mark ascriber 30 supports selection from available marks for insertion into a framework for the new block. The new block is preferably shown in an additional text window in such a way as to be visible at the same time as the original block, via the multi-focal viewer as described above. The mark ascriber 30 preferably allows user selection of marks as described, although in one embodiment, automatic selection of marks may be provided, based on randomness or alternatively on machine perceptions of the mark content. The ascribed mark browser 32 displays the selected marks from the ascribed framework, and thus may be viewed when writing in the block. That is to say, the ascribed mark browser provides an arrangement or framework, to allow the user to respond to the new arrangement of his existing ideas and thus facilitate his further writing.

In one preferred embodiment, inserted marks are provided with pointers to the new blocks with which they are associated, so that context association from the old block to the new blocks is additionally supported. Thus the mark preferably carries associations both with a new context, that of the new block into which it is propagated, and its original context.

Considering FIGS. 2 and 3 together, the user is encouraged to use the mark creator 22 to denote text representative of the central ideas of his writing and/or in the original text, and also to denote text representative of subsidiary or underdeveloped ideas in his writing. Thus, when the user opens a new block, he is able to use the marks to provide a framework in which certain of his previous ideas are presented in a new context, thus presenting new ideas. The new block thus provides him with a framework for creative development of his ideas.

Reference is now made to FIG. 4, which is a simplified block diagram showing in greater detail the spatial expositor 16 of FIG. 1. The spatial expositor 16 is associated with the mark creator 22 to allow the user to generate a spatial exposition based on selected marks and to add to the exposition further marks as desired. The spatial expositor 16 comprises a form creator 42, which creates form instances for defining spatial expositions. A mark placer 44, allows additional marks to be added to the form. An inner layer positioner 46 allows marks to be assigned to an inner layer of the exposition, and an outer layer positioner 48 allows marks to be assigned to an outer layer of the exposition. As will be discussed in more detail below, a two or more layer structure gives the user the possibility of building into his exposition a relationship between types of ideas, for example he may define a layer of structured content and a layer of structuring content. A form manager 47 is provided to manage the forms for respective spatial expositions.

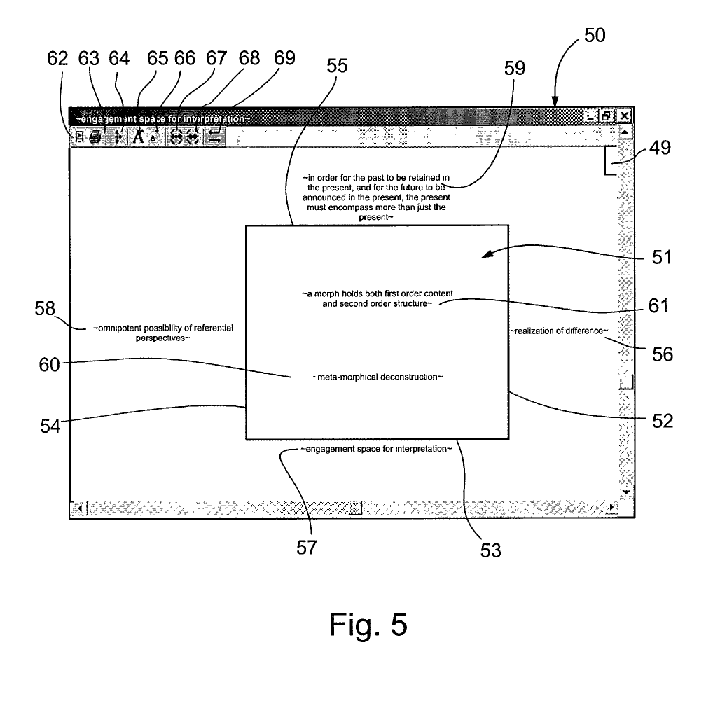

It will be appreciated that there are numerous ways in which a two (or more) layer geometry can be represented on screen, and one particularly preferred geometry is shown in FIG. 5, to which reference is now made. FIG. 5 shows a form, which is associated with a user selected mark, the mark being represented through a pop-up display 49. The window 50 can be reached by selection of the mark, either directly from the text or via a form management window, which will be described in detail below. Within the window 50 there is provided a closed geometric shape 51 in which outer edges 52, 53, 54, and 55, are assigned respective outer layer marks 56, 57, 58 and 59. Inner layer marks 60 and 61 are simply placed inside the shape. In a further preferred embodiment, the outer part of the shape is divided into edges and each edge is assigned with an outer layer mark. Inner layer marks are placed inside the shape. The further preferred embodiment thus allows for the depiction of marks in two layers. Of course the skilled person will appreciate that more than two layers may be used, for example an intermediate layer may provide structuring to an inner layer but may itself be structured by an outer layer.

At any point in the textualization process, one may choose to use the spatial expositor 16 to create a spatial representation of certain marks and their interrelations—hence, moving from composition thereof to their exposition. Through the graphic representation 50 described above, one may profit threefold: firstly by gaining a visual perspective on that which was composed; secondly by organizing one's ideas through construction build-up; and thirdly by creating a contextual orienting construction enabling one to move throughout the text via anchoring marks.

In the bar at the top of the form a series of buttons 62 to 69 provide functions as follows:

A first button 62 saves the mark references in the form.

A second button 63 prints the form. A third button 64 removes a mark from the form, and fourth and fifth buttons, 65 and 66 respectively, enlarge and reduce font sizes of selected marks in the form. Buttons 67 and 68 respectively enlarge and reduce the size of the shape of the outer layer represented in the form. Button 69 interchanges a mark's position in the outer layer.

The spatial exposition 50 is arranged in levels of organization, having outer layers, providing for the positioning of marks that function as structuring textual domains, and inner layers, providing for the positioning of marks that function as structured textual domains. One may create as many layers as one requires in the representation of the composition. The layers of exposition function as the manifestation of the structuring-structured unity. Thus, they enable the presentation of the hyper-contextual interplay in a spatial inter-textual domain, and the interrelations between marks in a multi-level organization. One may create as many spatial exposition forms as one requires, and place any mark at any layer in any form.

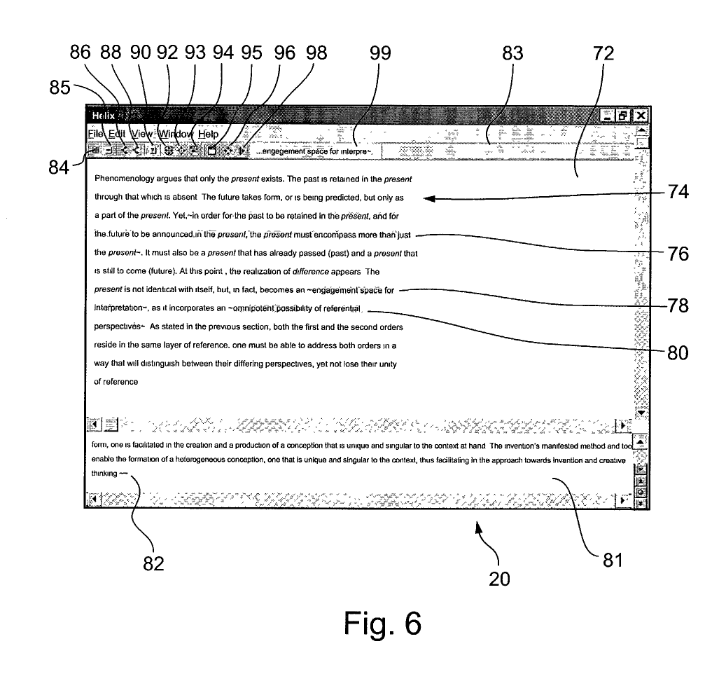

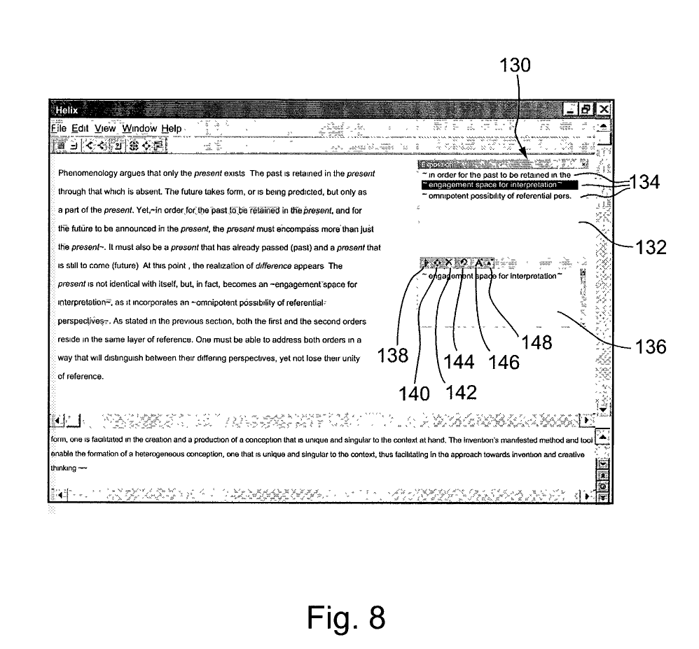

Procedurally, to integrate a mark into a form, one reaches a chosen mark in the text, and selects the mark. Then one designates whether it is to perform as a structuring textual domain or a structured textual domain via activation of the inner or outer layer positioners as appropriate. The layer positioners are preferably implemented as menu items or as buttons. Thus layer assignment may typically be achieved by pressing ‘Add in Outer Layer’ 98 or ‘Add in inner Layer’ 96 buttons respectively as shown in FIGS. 6 and 7 below, and which are further represented by reference numerals 138 and 140 in FIG. 8, as will be discussed below.

If there is more than one form to choose from then the user specificies to which form it is to be allocated, preferably by dragging to the relevant form or alternatively by pressing the desired form to make it the active form, or by selecting a form from a form manager or from a form manager window 130?).

The mark preferably appears in the chosen form with a designated layer. Marks to be associated with an outer layer of a shape or exposition are preferably associated with an outer boundary of the shape, each mark providing a separate edge. Inner layer marks are then assigned to the enclosed region, as described above. As such, when adding marks to the outer layer in a form, the boundary shape changes, and the number of edges of the enclosing shape is dependent on the number of marks in the outer layer.

The form allows for selection of a region in the shape to which a mark may be inserted, for reorganizing marks already located on the form, for example by moving the mark from one layer to another, and for removal of marks.

Marking represents an aspiration to refer to that which was mark-ed. Actualizing the aspiration is achieved by propagating the existing narrative in an act of writing, using the block creator 24. Further development of the narrative, to include new text-inspired ideas, is enabled, through the block creator 24, by the creation of a new textual block, as described above, which represents both a new section in the narrative's continuum, and a structuring boundary for the new text to be written within, whilst having new referential grounds. Procedurally, a ‘New Block’ button 86, shown in FIGS. 6 and 7 below, is provided which allows the user to perform the above function, opening a new block at the end point of the existing written text.

Having opened a new block, one may ascribe to the new block any textual references marked earlier using mark ascriber 30, which are felt to be relevant. In general, one can ascribe as many marks as one desires, at any time, and from any section of the narrative. The set of marks ascribed to the new block constitutes an inter-textual domain where the mark's content and context may interplay. The ascribed marks are viewed in the ascribed mark browser 32. From this point onwards, one writes in the new block in light of the interplay, reflecting a process of deconstruction and the emergence of difference. Writing in the newly mark-ascribed block reflects an understanding deriving from the mark's new engagement or context. Procedurally, to perform the propagation function one has to open a reference or feed forward mechanism window 100 for the designated Block, preferably achieved by pressing on a ‘Show Block’ button 88, to reach and select the relevant Mark and ascribe it to the Block's list of Marked references. The latter may be achieved by pressing an ‘Add to Block’ button 112. Marks may thus comprise sub-textual domains within Blocks. As such the block's ascribed marks are also attributed to all sub-textual domains, i.e. marks, within this Block. Since each sub-textual domain may require references differing from the block's references, one may ascribe an additional or different set of marks as references to that specific mark. Moreover, since the marks serve as references to different sections of the text, one may additionally view those blocks, or sub-textual domains thereof, whose marks have participated in the creation of referential ground, for example in the ascribed block presenter 34. That is to say, by selecting a mark, one is able to see its source block in one of the text windows, and preferably any blocks propagated from the mark. Such blocks are preferably available in the mark's reference window. In this way the reference window performs as a systemic function, enabling the development of referential grounds to encompass the text as a whole.

The feed forward mechanism window 100 thus also provides the contextual environment for the marks which brought about the propagation of the current block.

Reference is now made to FIG. 6, which is a simplified screen view showing two text holders as they appear in a multi-focal text editor 20 and exemplifying the textualization process. A first window 72 shows a block 74 of text. Within the block of text, certain contents 76, 78, and 80, are marked.

A second window 81 allows a further portion of text to be shown. The second window 81 is preferably used to show the end of the last block of the composition, and may serve as a space for creating new blocks, as desired using the feeding forward mechanism 14. The block creator 24 creates a new block for composition and is represented by the numeral 82. At the top of the screen view is a tool bar 83 having a series of buttons. A first button 84 is an activator for the mark creator 22, and serves to define currently selected texts as a mark. A second button 85 is associated with the mark creator 22 and is used to deselect a mark. A further button 86 is associated with the block creator 24 and is used to create a new text block. A further button 88 is associated with the feed forward mechanism 14 and is used to show the referential framework ascribed to the block. A button 90 operates a mark search for carrying out word searches over the currently defined marks.

The remaining buttons relate to the spatial expositor. A button 92 creates a form of the kind shown in FIG. 5, for a selected mark and its environment, the mark ascribed framework is positioned as an outer structuring layer, and corresponds to form creator 42. A button 93, also corresponding to form creator 42, opens an empty form for the selected mark. A button 94 closes currently open forms or mark viewers, if at all opened using button 126 It is noted that button 126 opens separate browse windows for each ascribed mark. A button 95 opens an exposition manager, otherwise referred to herein as a form manager, that provides management functions for the spatial exposition form creation process. Buttons 96 and 98 respectively correspond to inner layer positioner 46 and outer layer positioner 48 to assign currently selected marks to inner and outer layers of a current form, that is to say of a current spatial exposition. Button 99 is a form-in-focus indicator which can be pressed to display the form currently indicated. The forms are preferably represented in the indicator through the texts of the mark used to create them.

Reference is now made to FIG. 7, which is a screen view similar to that of FIG. 6, except that it further comprises a reference or feed forward mechanism window 100, which is essentially the user interface of the feed forward mechanism 14. Parts that are the same as those in previous figures are given the same reference numerals and are not described again except as necessary for an understanding of the present embodiment. The feed forward mechanism window 100 consists of a first part 102 which displays ascribed marks, for example designation 103 of mark 76. A second part 104, of the feed forward mechanism window, corresponds to ascribed block presenter 34 and shows a selected block, for example that designated 105, and corresponding to text 108. A third part 106, of the feed forward window, corresponds to ascribed mark browser 32 and shows full text 107 of any mark selected, as in the example of mark 103, thereby allowing a user to browse ascribed marks fully.

The window 100 in the state shown in FIG. 7 has a row of buttons which include a first button 110 which saves the set of mark references for a block, a second button 112 which adds a mark to block references, a third button 114 which removes a mark from block references, a fourth button 116 which leads to a selected mark in the text, a fifth button 118 which allows a user to swich from editing mode to browsing mode, a sixth button 120 to open and close sub-window 104 corresponding to ascribed block presenter 34, seventh and eighth buttons 122 and 124 for respectively enlarging and reducing font size in the feed forward mechanism window, and a ninth button 126 for opening all mark references in separate windows.

Reference is now made to FIG. 8, which is a simplified diagram showing an exposition form manager window 130 for managing the creation and use of forms of the kind shown in FIG. 5. The window is the user interface for form manager 47 referred to hereinabove. The window comprises a form selection region 132 showing available forms 134 via the marks used to create the form, and a selected mark region 136 for full textual display of the mark. Double clicking on the marks in the form selection region 132 preferably opens the corresponding form.

Form management buttons are provided as follows: A button 138 allows for the placement of a currently selected mark in the outer region of a form. A button 140 allows the placement of the currently selected mark in an inner region of the currently selected form. A delete button 142 allows for deletion of the currently selected form. A ‘goto’ button 144 allows the user to go to the selected mark, representing the form, in the text, and buttons 146 and 148 allow respectively for increasing and decreasing font size in the form management window 130.

Different forms can be opened in different windows, and it is possible to provide cascading windows of the different forms. Furthermore, if the host computer has suitable hardware, it is possible to display different windows on different screens. The ability to display different windows on different screens is of course not restricted to forms but applies to the tool in general.

At the end of the process described above, the embodiments are able to provide a developed composition and a set of expositions, both representing an act of metamorphic deconstruction in a textualized development of a user's conception. Through the ability to represent hyper-contextual interplay in an inter-textual engagement domain, whether in composition or exposition form, one is facilitated in the creation and the production of a conception that is unique and singular to the context at hand. That is to say, the above described method and tool enable the formation of a heterogeneous conception that is unique and singular to the context, thus facilitating an approach towards invention and creative thinking.

The present embodiments are considered in conceptual terms. Phenomenology argues that only the present exists. The past is retained in the present through that which is absent. The future takes form, or as one would say, is predicted, but only as a part of the present. Yet, in order for the past to be retained in the present, and for the future to be announced in the present, the present must encompass more than just the present. It must also contain within itself a present that has already passed and a present that is still to come (future). The consideration of the present in the above light leads to the realization of difference. The present thus is not identical with the present in the narrowest sense, but, in fact, becomes an engagement space for interpretation, as it incorporates potentially encompassing possibilities of referential perspectives. The emergence of difference reflects the present as being a state of potential. As such, it represents a process of meta-morphical deconstruction. In the metamorphical deconstruction process, a morph holds both first order content and second order structure (meta-morphical), and deconstruction provides the ability to metamorphose through the realization of difference.

As stated in the previous section, both the first and the second orders reside in the same layer of reference. One must be able to address both orders in a way that will distinguish between their differing perspectives, yet not lose their unity of reference.

We subjectively interpret objects using language. The sign, the thing that is distinguished and articulated by a system of differences, is all that there is in the domain of the cognizing entity. Therefore, language ceases to be secondary, it is not provisional, nor just marking time nor keeping place until the object or event arrives, since things themselves are linguistically constituted. In such a sense, the world itself is discourse, actualized through the emergence of difference in the interpretation of the context at hand. The grounds for such a discourse must allow an investigation of the present as a continuum, and not as an instant in time, since difference is manifested counterfactually.

In the practice of living within and through language, writing offers a means for overcoming the temporal by simulating the immediacy of speech, hence allowing for continuous engagement and consequently for difference to be realized. In this sense, texts may provide the grounds and meta-grounds upon which deconstruction may occur.

Every process of writing, either in an attempt to organize one's thoughts or in the process of brainstorming towards innovation, reflects the development of an underlying conception or an act of rationalization. Considering a conception as an interpretive construction, the conception is composed in an act of textualization by morphological texts. The morphological texts form the ideas in the process of conception design. In the first-order, the texts hold their symbolic schema, and in the second-order they hold their existence reflected in structure. Structure in turn, reflects the continuous systemic interplay of morphs encompassed by the conception's structure. The interplay of morphs represents an engagement between the different referential grounds or contexts. As such, regarding the second-order, texts are hyper-contextually interrelated, as each morphed text takes part in the conception's structure. The morphed texts embody different interpretive perspectives, which may be projected as references upon the existing text, thus having a morphological effect on it.

Thus, writing through hyper-contextual relations provides the ability to relate to the formation of the conception, focusing on the process as a changing and interrelating point of reference, rather than merely regarding the text as a product. Hence, these underlying contextual interrelations enable one to realize the morphology embodied in the text, which is derived from its part in the conception's structure. Realization of the morphology then enables one to propagate the undertaking of textual morphs through a process of metamorphosis—an act of new idea creation and thought organization, where textual morphs are textualized. Such is achieved using the feed forward mechanism 14 described above, which provides the conception's structure with the grounds formetamorphosis.

One tends to focus on the text's content in the process of creation. One tends to remain unaware of the process's development point of reference, embodied in the path taken by the process which progresses with relation to the texts created. Directing one's focus on the path of formation within the process of text creation, enables one to question not only the process's manifestation at each moment, but also to introspect and question the act of the processing itself. It broadens the view from the narrow one-dimensional perspective of the self-containing production of text, to the space within which the process's formation takes place. Thus, it enables one to consider the present process, in relation to its underlying past and future projections, as a unified whole comprising multi-perspective potential for change. Furthermore, since the act of metamorphosis relies on the ability to understand the content together with its underlying structure, the ability to create new texts may take place whilst building up a new organizing rationalization that reflects the process's structuring. Metamorphosis towards the new can thus be reached by realizing the morphological meta-domain—namely by looking at the relations between texts. The inter-textual domain, during the act of text creation, reflects hyper-contextual relations, thus relating to the unity of structure and structuring.

As cited before, Koestler suggested that the basis of creativity is the “perceiving of a situation or an idea in two self-consistent but habitually incompatible frames of reference” (Wilkins, 1988, pp. 351-352). Moreover, as stated before, in order for one to conceive matters in a new and different way, one must be able to conceive different referential grounds for the matter at hand. Focusing on the referential grounds, one may choose to look at Koestler's phrase from a different perspective, viz: working through references provides for the realization of difference, enabling us to deconstruct and metamorphose—thus furnishing a potential for creation.

Writing through references retains the idea of both first-order content and second order structuring residing in the same space and time within the text and the act of text creation. It is a process of accommodation—the changing of our cognitive structure in an attempt to understand a context differently. It encompasses the textual building blocks and the meta-textual domain, a domain where differing points of reference emerge and affect the course of textualization, and hence the assembly of building blocks, together with a revised understanding of the building blocks themselves, that is to say to achieve new building blocks.

Methodologically, writing through references, using the mark creator, mark ascriber and the feed forward mechanism, creates a continuous potential of difference realization. As a result, writing becomes the potential for more writing—we continue to create our narrative in reference to the narrative already created, the driving force for the creation deriving from that which was written (in the first order), together with the investigation of the form it was written in (in the second order). Both perspectives are laid out in the progressing narrative and provide on the one hand a growing understanding of the matter interpreted, and on the other hand a point of reference on both orders for further progression. As such, the driving force, encompassing references and the continuum of writing, exceeds the well-known existing feedback mechanisms because the function of the references not only points to earlier production, but also holds the structural grounds in the process of contemporary creation. As such, writing through references preferably integrates a feed-forward mechanism, in which narrative continuation reflects the emergence of the realized difference, whist considering the interplay of prior written texts as engaging points of reference. Thus, the feed-forward mechanism performs both as a spatial browser—relating to the text counterfactually, and as a temporal browser—relating to the spatial engagement as a point of departure towards a new factual path. The former counterfactual span provides the potential for creation, whereas the latter, in its factual manifestation, provides an embodiment for the materialization of creation. Hence, writing through references, as a methodology facilitating invention or creative thinking, is possible through retaining the ability to realize the potential created when engaging points of reference up to the emergence of difference, and using this potential as a feed-forward driving force in the progression of the narrative.

The above described embodiments provide the necessary tool for writing through references and for understanding buildup and deconstructing contexts, thereby to facilitate the creative processes.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. Creative thinking tool, operative on text, said tool comprising:
a mark creator for allowing a user to mark portions of text; and
a feed forward mechanism, associated with said mark creator, for assisting with propagation of said text at a new block in said text, said feed forward mechanism comprising:
a mark ascriber for allowing a user to ascribe selected marks with said new block, and
a selected mark display for displaying said ascribed marks as a framework for creating new text into said new block.

2. The tool of claim 1, wherein said mark ascriber comprises a reference for retaining with each ascribed mark an association with a respective mark of origin in said text, such that an ascribed mark ascribed to a new block is selectable to automatically display a respective mark of origin.

3. The tool of claim 2, wherein a block is selectable to automatically display marks ascribed thereto.

4. The tool of claim 1, wherein said feed forward mechanism comprises a mark text window for displaying of texts of selected marks.

5. The tool of claim 1, further comprising a search device, associated with said mark creator, for carrying out text searches of said marks.

6. The tool of claim 1, further comprising a multi-focal viewer for simultaneously displaying a plurality of windows.

7. The tool of claim 6, wherein said multi-focal viewer is operable to simultaneously display a block of origin of an ascribed mark and a block to which said mark is ascribed.

8. The tool of claim 1, further comprising a spatial expositor for arranging user selected marks in a layered spatial arrangement, thereby to display graphically, relationships within said text.

9. The tool of claim 8, wherein said marks are ascribed marks and respectively comprise references for retaining an association with a respective mark of origin in said text, such that a mark in said layered spatial arrangement is selectable to automatically display a respective mark of origin.

10. The tool of claim 8, wherein said spatial expositor comprises a layering selector for allowing a user to select a layer within said arrangement for placement of a given selected mark.

11. The tool of claim 8, wherein said spatial expositor is interfaceable to users via forms.

12. The tool of claim 11, wherein instances of said forms are generatable from marks.

13. The tool of claim 11, wherein said spatial expositor is operable to create a user determined number of said spatial arrangements, each one of said spatial arrangements being user manipulable.

14. The tool of claim 12, wherein respective instances of said forms are retrievable by reference to corresponding marks.

15. The tool of claim 13, wherein respective mark associations are retrievable via said form.

16. The tool of claim 8, wherein each said mark is assignable to a user selectable one of at least an outer layer and an inner layer of a respective layered spatial arrangement.

17. The tool of claim 16, wherein at least one spatial arrangement comprises outer edges and an inner region, and wherein said outer layer marks are represented in said spatial arrangement by said outer edges and said inner layer marks are located in said inner region.

18. Creative thinking tool, operative on text, said tool comprising:
a mark creator for allowing a user to mark portions of text at an originating location; and
a spatial expositor for arranging user selected marked portions in a layered spatial arrangement, thereby to display graphically, relationships within said text.

19. The tool of claim 18, wherein said spatial expositor comprises a reference retainer for retaining with each arranged mark an association with a respective point of origin in said text, such that an arranged mark in said layered spatial arrangement is selectable to automatically display text at said respective originating location.

20. The tool of claim 18, wherein said spatial expositor comprises a layering selector for allowing a user to select a layer within said arrangement for placement of a given selected mark.

21. The tool of claim 18, wherein said spatial expositor is interfaceable to users via an instance of a form.

22. The tool of claim 21, wherein said spatial expositor is operable to create a user determined number of said spatial arrangements, each one of said spatial arrangements being user-manipulable via arrangement of marks.

23. The tool of claim 22, wherein each of said mark associations is retrievable via said form.

24. The tool of claim 18, wherein each said mark is assignable to a user selectable one of at least an outer layer and an inner layer of a respective layered spatial arrangement.

25. The tool of claim 24, wherein at least one spatial arrangement comprises outer edges and an inner region and wherein said outer layer marks are represented in said spatial arrangement by said outer edges and said inner layer marks are within said inner region.

26. Text arranged into a plurality of blocks, at least some of said blocks having text associated with marks from respective mark origin ones of said blocks, and each mark comprising textual content and having a context in said respective mark origin block, said text associated with said mark further comprising an activatable association with said mark origin block, thereby to indicate said context, and said marks further being selectable for inclusion into a framework for construction of a new block whilst retaining said activatable association thereby to form an association between said new block and said block of origin.

27. The text arranged as in claim 26, wherein each mark comprises said textual content and said textual context, and wherein said textual context comprises surrounding text in said block of origin and marks assigned to said block of origin.

28. The text as arranged in claim 27, such that each mark is contextually associated and retrievable via said surrounding text.

29. The text arranged as in claim 27, wherein respective ones of said blocks have associations defined therebetween via marks, thereby to form a structural environment within said text.

30. Method for providing automatic assistance for creative thinking in textual construction, the method comprising:
marking portions of text,
selecting ones of said marks to form a framework,
displaying said framework simultaneously with a text creation region for stimulating said text formation process.

31. The method of claim 30, further comprising providing said selected marks with pointers to respective portions of text, thereby to render said selected marks to be selectable from said framework to display said portion of text for further stimulating said text formation process.
